(19) United States
(12) Patent Application Publication
(10) Pub. No.: US 2012/0222595 A1
(43) Pub. Date: Sep. 6, 2012

(54) PUNCH NEEDLE AND SEWING MACHINE

(75) Inventors: Rino NAKAMA, Konan-shi (JP); Yasuhiko Kawaguchi, Nagoya-shi (JP); Noboru Mizuno, Nagoya-shi (JP); Tomoyasu Niizeki, Ichinomiya-shi (JP)

(73) Assignee: BROTHER KOGYO KABUSHIKI KAISHA, Nagoya (JP)

(21) Appl. No.: 13/409,334

(22) Filed: Mar. 1, 2012

(30) Foreign Application Priority Data
Mar. 2, 2011 (JP) 2011-045070

(51) Int. Cl. D05B 81/00; B43L 13/00

(52) U.S. Cl. 112/2; 33/18.1

(57) ABSTRACT

A punch needle is disclosed. The punch needle is detachably attached to a needle bar of a sewing machine and is configured to punch a workpiece by moving the needle bar up and down. The punch needle including a base section detachably attached to the needle bar; a mid section in continuation with the base section; a tip section formed on the end of the mid section; and a handle provided on the mid section, the handle being configured to be held by a user's fingers during attachment/detachment of the base section to/from the needle bar.

### CROSS-REFERENCE TO RELATED APPLICATION(S)

This application is based upon and claims the benefit of priority from the prior Japanese Patent Application 2011-045070 filed on Mar. 2, 2011, the entire content of which are incorporated herein by reference.

### FIELD

The present disclosure relates to a punch needle being detachably attached to a needle bar of a sewing machine and being used for punching a workpiece by moving the needle bar up and down. The present disclosure also relates to a sewing machine provided with such punch needle.

### BACKGROUND

Multi-needle embroidery sewing machines are available that are capable of executing uninterrupted embroidery sewing operation with multiple thread colors. Such multi-needle embroidery sewing machines are typically provided, at the end of its arm, a needle-bar case containing six needle bars for example. A given needle bar is selected from the choice of needle bars and is attached to a needle-bar drive mechanism to be driven up and down. The embroidery sewing machine is further provided with a controller that receives input of pattern data that contains instructions on needle drop positions and timings for changing the thread color, etc. Based on the pattern data, the controller transfers an embroidery frame holding the workpiece in the X and Y directions by a transfer mechanism while controlling the needle-bar drive mechanism to execute an embroidery sewing operation with multiple colors of embroidery thread.

New applications for embroidery sewing machines are being proposed and one of such applications utilizes the embroidering feature of the sewing machine to create engravings on the workpiece by replacing the sewing needle with a punch needle. The needle bar carrying the punch needle is driven to strike the workpiece to leave behind markings on the workpiece that appear as decorative patterns. In executing the punch engraving operation, an embroidery frame that holds the embroidery workpiece in an embroidering operation is replaced by a holder frame for holding the punch workpiece. The holder frame is attached to the carriage of the transfer mechanism and moved in the X and Y directions. The punch workpiece is typically made of materials such as a resin, aluminum, and brass. The punch needle is attached to the needle bar driven up and down while the holder frame is transferred in the X and Y direction by the transfer mechanism based on data prepared for punch engraving to form the desired punch engraving on the workpiece. A sheet of paper or resin may be employed as the workpiece to form patterns of holes.

A sewing needle or a punch needle is secured to the needle bar of the sewing machine by inserting the base section into a hole provided on the needle bar.

Because the punch needle is designed to leave markings on the top surface of the workpiece, the punch needle is shorter in length compared to the sewing needle. Thus, when attaching/detaching the punch needle to/from the sewing needle, the user was required to hold the punch needle by portions other than the base section. Because a firm hold of the punch needle may be not be established depending upon, for instance, the size of the user's fingers, pliers were used in some instances which made the attachment and detachment of the punch needle cumbersome.

### SUMMARY

One object of the present disclosure is to provide a punch needle that can be easily attached to/detached from the needle bar by allowing a firm hold of the punch needle and a sewing machine provided with such punch needle.

In one aspect of the present disclosure there is provided a punch needle detachably attached to a needle bar of a sewing machine and that is configured to punch a workpiece by moving the needle bar up and down. The punch needle comprises a base section detachably attached to the needle bar; a mid section in continuation with the base section; a tip section formed on the end of the mid section; and a handle provided on the mid section, the handle being configured to be held by a user's fingers during attachment/detachment of the base section to/from the needle bar.

Other objects, features and advantages of the present disclosure will become clear upon reviewing the following description of the illustrative aspects with reference to the accompanying drawings.

### BRIEF DESCRIPTION OF THE DRAWINGS

FIG. 1 is a general front view of a sewing machine of a first embodiment;

FIG. 2 is a general perspective view of a holder frame;

FIG. 3 is an enlarged cross sectional view of the tip of a punch needle and articles in which the tip is plunged into when a needle bar is in its lowermost position;

FIG. 4A is an enlarged front view of the structures for establishing the attachment of the punch needle with the needle bar;

FIG. 4B is a cross sectional view taken along line IVb-IVb of FIG. 4A;

FIGS. 5A is a front view of the punch needle;

FIG. 5B is a plan view of the punch needle;

FIG. 6A is a front view of a needle body;

FIG. 68 is a side view of the needle body;

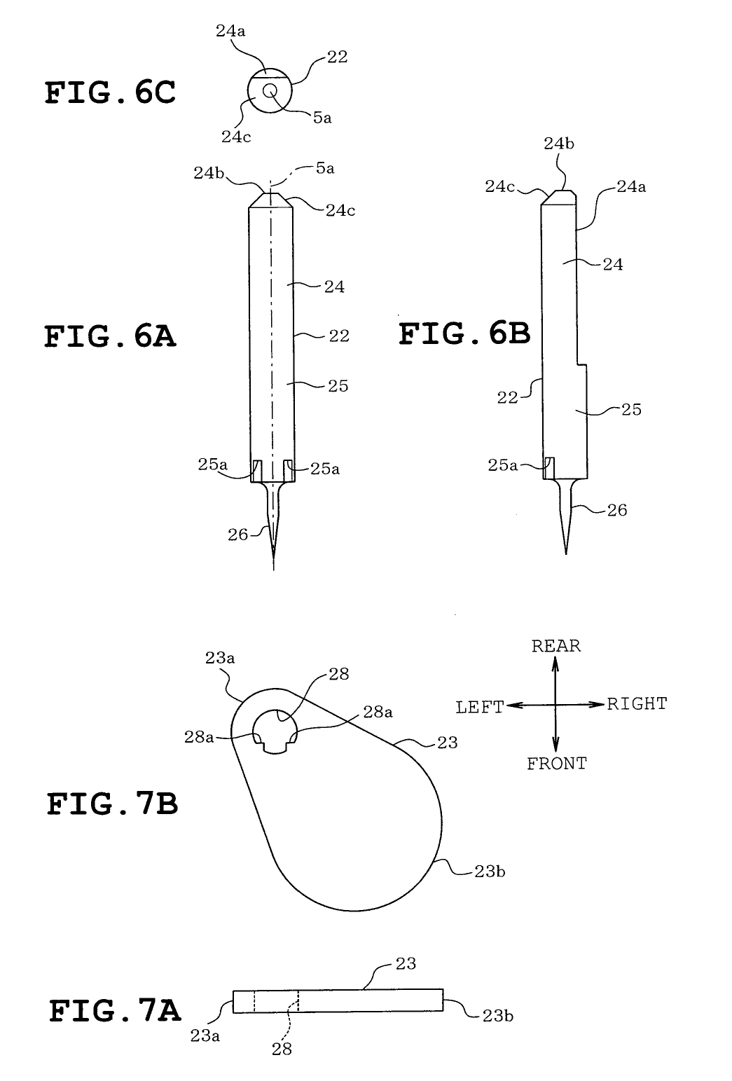

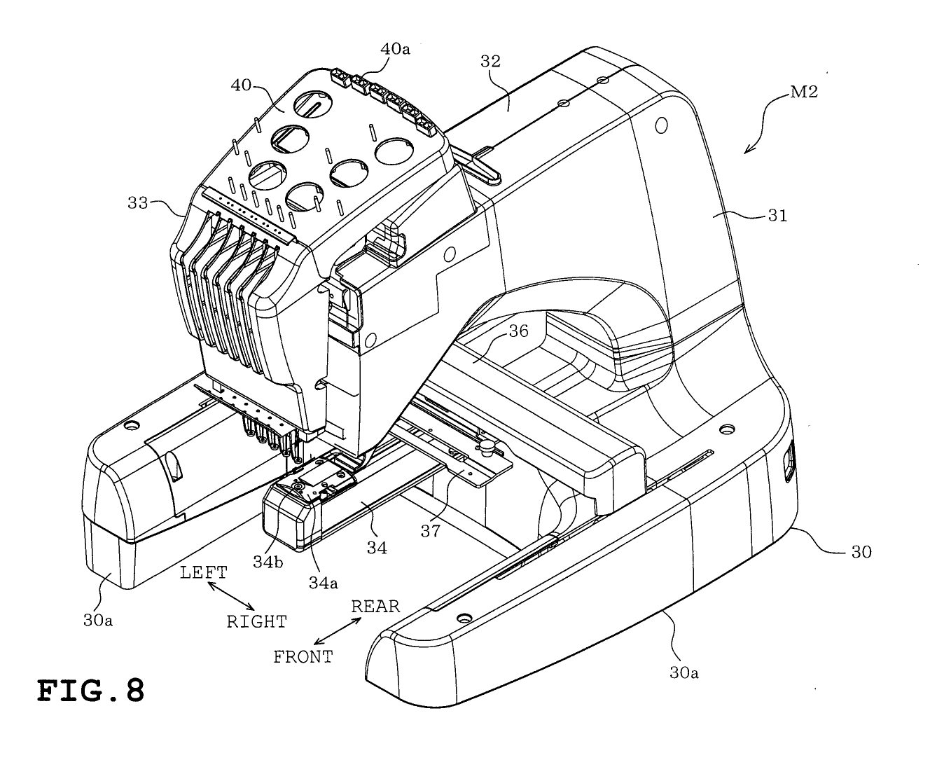

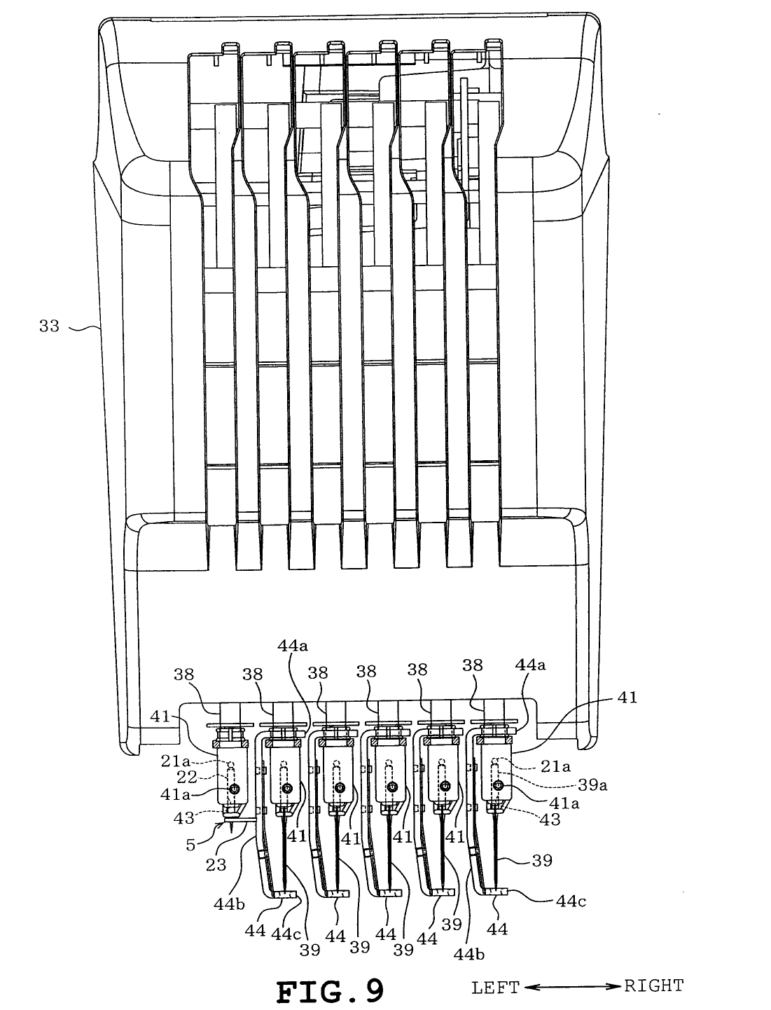

FIG. 6C is a plan view of the needle body;

FIG. 7A is a front view of a handle;

FIG. 7B is a plan view of the handle;

FIG. 8 is a general front view of a multi-needle sewing machine of a second embodiment; and

FIG. 9 is front view of a needle-bar case.

### DETAILED DESCRIPTION

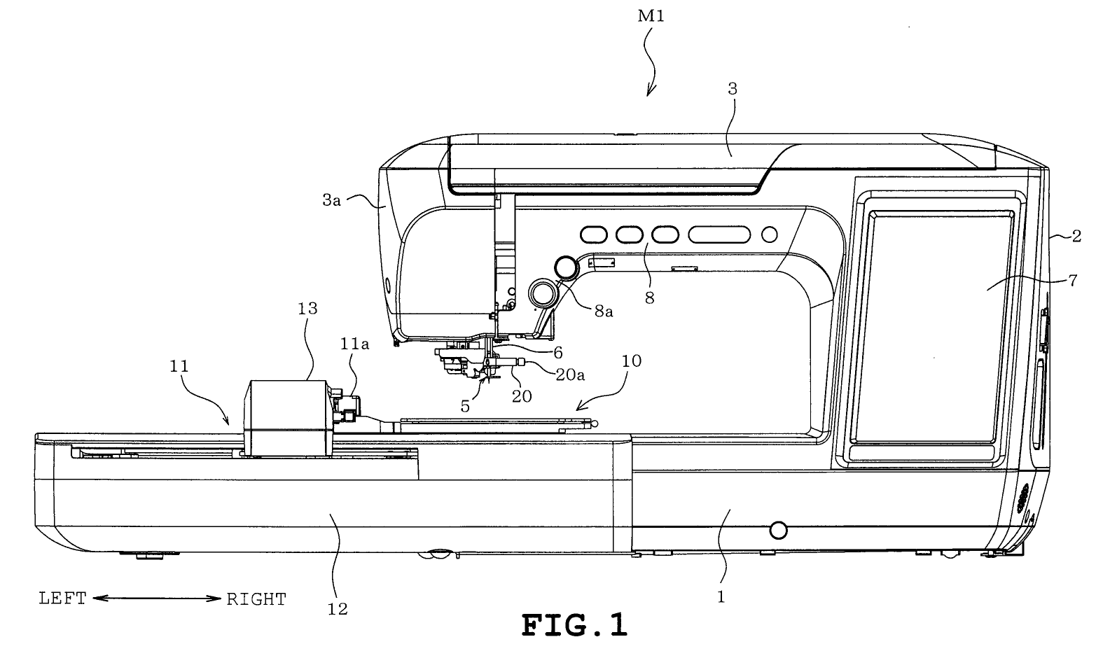

A first embodiment of the present disclosure is exemplified through a household sewing machine hereinafter referred to as sewing machine M1 and will be described in detail with reference to FIGS. 1 to 7B.

Referring to FIG. 1, sewing machine M1 is primarily configured by bed 1, pillar 2, and arm 3 that are structurally integral. Pillar 2 extends upward from the right end of a laterally oriented bed 1. Arm 3 extends leftward from the upper portion of pillar 2 and terminates into head 3a. Arm 3 contains a laterally extending main shaft not shown of the sewing machine. Pillar 2 contains sewing machine motor not shown that drives the main shaft in rotation. Description will be given hereinafter with an assumption that the direction in which the user/operator positions himself/herself to face sewing machine M with arm 3 extending in left and right direction is the forward direction and the opposite side, naturally, is the rear direction, in other words, the direction normal'to the page of FIG. 1 is the forward and the rear direction.

Head 3a is provided with needle bar 6. Needle bar 6 has a sewing needle not shown or a later described punch needle 5 attached to it. Though not shown, arm 3 further contains components such as a needle-bar drive mechanism, a needle-bar swing mechanism, a thread take-up drive mechanism, and a presser-bar drive mechanism. The needle-bar drive mechanism moves needle bar 6 up and down through the rotation of the main shaft. The needle-bar swing mechanism swings needle bar 6 in a direction orthogonal to the direction in which the workpiece is fed. In the first embodiment, needle bar 6 is swung in the left and right direction. The thread take-up drive mechanism drives the thread-take up in synchronism with the up and down movement of needle bar 6. The sewing needle being known to be used in an ordinary sewing operation will not be described in detail.

On the front side of pillar 2, a sizable and vertically elongate liquid crystal display 7 capable of displaying in full color is provided, which is hereinafter simply referred to as LCD 7. LCD 7 displays various information such as messages to the user and various user interfaces such as screens for providing instructions, making selections and inputs. On the front side of arm 3, various key switches 8 are provided such as start/stop switch 8a for starting and stopping a sewing operation.

On the upper surface of bed 1, needle plate not shown is provided. Within bed 1 below needle plate, components such as a feed mechanism, a horizontal rotary hook mechanism, and a thread cutter are provided neither of which are shown. The feed mechanism drives a feed dog up and down and back and forth. The horizontal rotary hook mechanism contains a bobbin and forms stitches in cooperation with the sewing needle. The thread cutter mechanism cuts needle thread and bobbin thread.

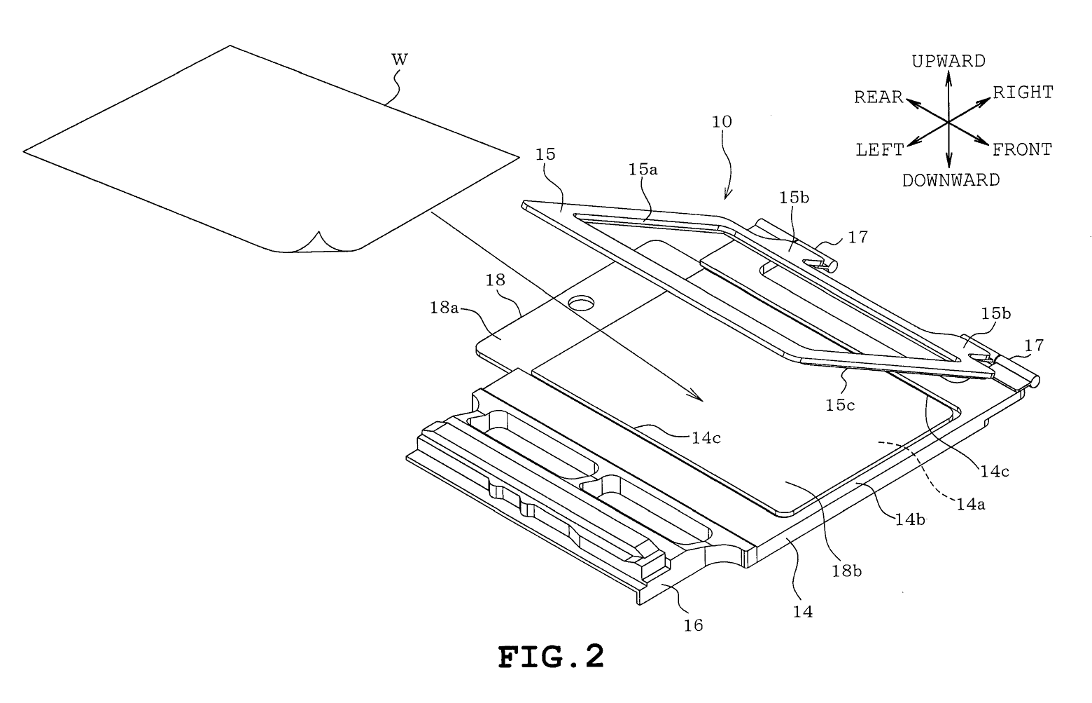

Bed 1 allows detachable attachment of transfer device 11 at its left end. Transfer device 11 is provided with carriage 11a that allows detachable attachment of an embroidery frame that holds a workpiece to be sewn neither of which are shown. Carriage 11a also allows detachable attachment of holder frame 10 shown in FIG. 2 that holds workpiece W subjected to a later described punching operation. As shown in FIG. 1, transfer device 11 is primarily configured by body 12 and movable section 13. Body 12 is substantially level with the upper surface of bed 1 when transfer device 11 is attached to bed 1. Movable section 13 is provided on the upper surface of body 12 so as to be movable in the left and right direction over body 12. Movable member 13 is provided with carriage 11a that allows detachable attachment of the embroidery frame or holder frame 10 and that is movable in the front and rear direction relative to movable member 13. Transfer device 11 is further provided with an X-direction transfer mechanism and Y-direction transfer mechanisms that are neither shown. The X-direction transfer mechanism drives the carriage 11a as well as movable member 13 in the left and right direction. Y-direction transfer mechanism drives carriage 11a in the front and rear direction. The embroidery frame and holder frame 10 are driven in the X direction representing the left and right direction and the Y direction representing the front and rear direction by the X-direction transfer mechanism and the Y-direction transfer mechanism.

Next, a description will be given on holder frame 10. As shown in FIG. 2, holder frame 10 is configured by a generally rectangular lower frame 14 and upper frame 15 provided over lower frame 14. On the left end of lower frame 14, connecting section 16 is provided for rendering the attachment of lower frame 14 to carriage 11a. On the right end lower frame 14, a pair of front and rear pivot sections 17 are provided for pivoting upper frame 15.

Upper frame 15 is configured as a relatively thin rectangular frame having a middle opening 15a. A pair of front and rear extensions 15b is formed on one of the longer sides of upper frame 15 which is the right side as viewed in FIG. 2. Upper frame 15 is connected to pivot section 17 by way of extensions 15b. Thus, upper frame 15 is pivoted between a clamp position shown in FIG. 1 placed in contact with lower frame 14 to clamp workpiece W and a release position shown in FIG. 2 separated away from lower frame 14 to release the hold of workpiece W. Though not shown in detail, magnet 15c is provided along the bottom surface of upper frame 15.

Lower frame 14 is made of a metal plate and is provided with recess 14a having an enclosed bottom surface located which is laterally centered on the metal plate. Recess 14a is configured to receive placement tray 18 inserted from the rear side. More specifically, recess 14a is surrounded on three sides by a U-shaped frame section 14b comprising an uprising inner wall that opens up toward the rear side to accommodate placement tray 18. The inner wall of frame section 14b has grooves 14c caving outward to allow the insertion of placement tray 18 from the rear side so that it can be held within recess 14a.

Placement tray 18 is configured by a rectangular panel 18a held by guide grooves 14c and an elastic member 18b smaller in size than panel 18a. Elastic member 18b is affixed to panel 18a by adhesives such as double stick tape and is affixed by a level of adhesion that would allow the user to peel it off by hand from elastic member 18b. Elastic member 18b is made of an elastic material like urethane foam, rubber or other flexible material which possesses a level of elasticity to absorb the impact of punch needle 5 tip. The upper surface of elastic member 18b is coplanar with the upper surface of frame section 14b of lower frame 14.

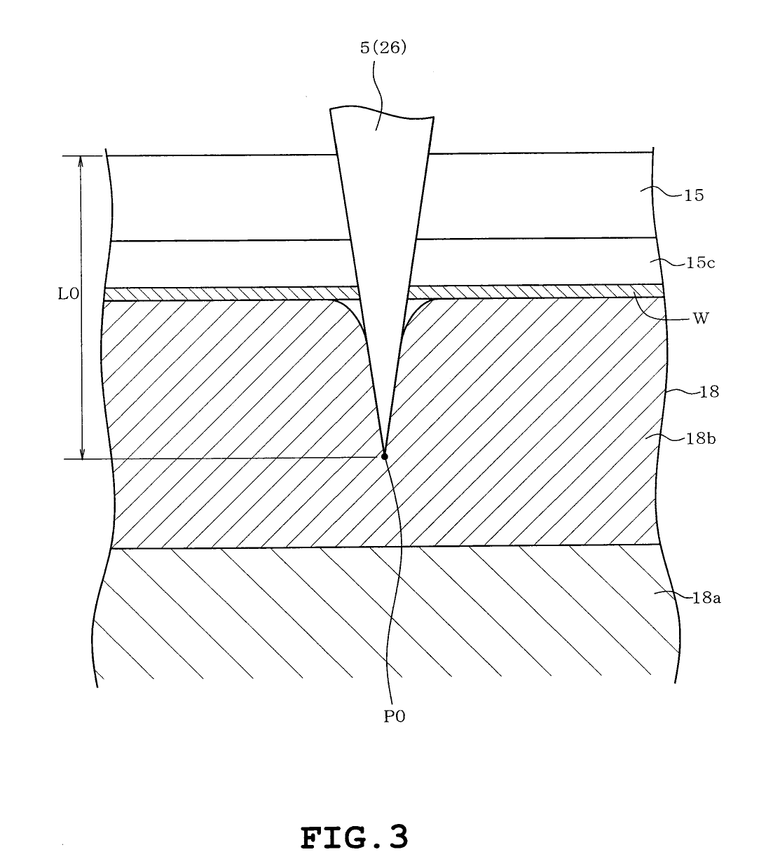

As shown in FIG. 3, the thickness of elastic member 18b is configured such that when needle bar 6 is at the lowermost point of its reciprocation, tip section 26 of punch needle 5 penetrates workpiece W but does not reach the upper surface of panel 18a. This means that when needle bar 6 is at the lowermost point of its reciprocation, punch needle 5 penetrates workpiece W overlying elastic member 18b but does not penetrate elastic member 18b. Placement tray 18, is held by forces not limited to friction between the edge of panel 18a and guide groove 14c and friction between the bottom side of panel 18a and the bottom wall of recess 14a. Thus, the above described configuration prevents unintended displacement of placement tray 18 from recess 14a even when oscillated by the impact of the later described punch operation.

Holder frame 10 is detachably attached to carriage 11a of transfer device 11 by way of connecting section 16. In operation, holder frame 10 is opened by the user as illustrated in by moving upper frame 15 away from lower frame 14 to the release position. Then, the user is to place workpiece Won elastic member 18b and close upper frame 15 as illustrated in FIG. 1 toward lower frame 14 to the clamp position. Magnet 15c provided on the underside of upper frame 15 is attracted to lower frame 14 to cause upper frame 15 to be placed over workpiece W overlying elastic member 18b and clamp workpiece W with lower frame 14. Workpiece w, when clamped by holder frame 10, has its punch workface placed on elastic member 18b exposed through opening 15a of upper frame 15.

Holder frame 10 is not limited to the above described structure but may come in different sizes and shapes depending upon the sizes and shapes of the workpiece W.

The embroidery frame for holding the workpiece W also coming in different sizes and shapes is provided as an accessory to the sewing machine as well known and thus, will not be described in detail.

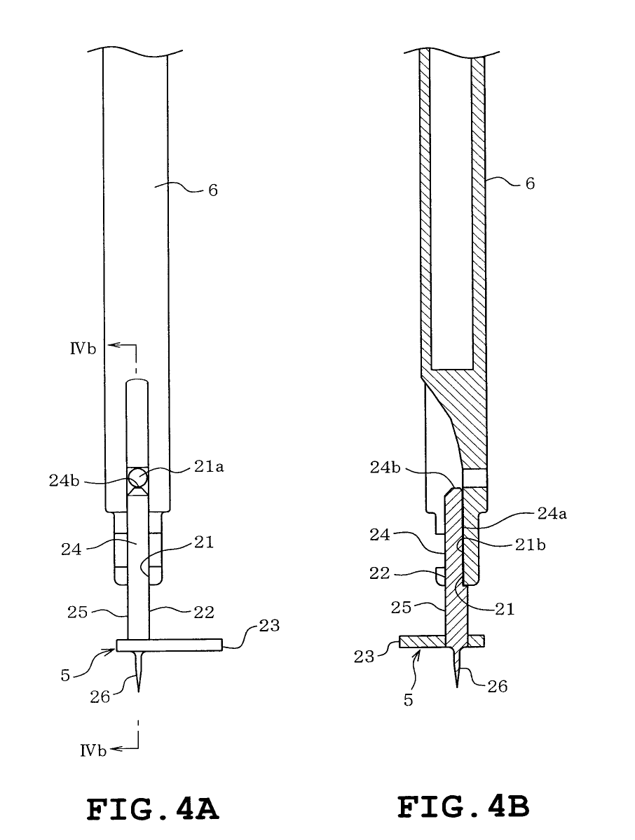

Sewing machine M1 of the first embodiment is capable of executing a normal embroidery sewing operation on the workpiece with embroidery thread as well as executing a punching operation on the workpiece. The punching operation is executed by impinging, in this case, piercing punch needle 5 dot by dot on the surface of workpiece W while transferring holder frame 10 in the X and Y directions by transfer device 11 to form multiplicity of markings, which are typically small holes, on workpiece W. Examples of workpiece W for punching operation include a sheet of paper or a resin film which are 1 mm or thinner. Further, the punching operation is executed by attaching punch needle 5 to needle bar 6 instead of the sewing needle. The configuration of the attachment subject on needle bar 6 will be described in detail with reference to FIGS.4A and 4B.

Needle bar 6 has lower end 3a protruding downward from head 3a and is reciprocated up and down by the needle-bar drive mechanism between the uppermost position and the lowermost position. At the lower end of needle bar 6, needle clamp 20 shown in FIG. 1 is provided for mounting the sewing needle or punch needle 5 on needle bar 6. FIGS. 4A and 4B are enlarged view of the lower section of needle bar 6 without needle clamp 20. As shown in FIG. 4A, the lower end of needle bar 6 has hole 21 defined thereto that is configured as an insert groove extending in the up and down direction. At the upper end of hole 21, stopper 21a only shown in FIG. 4A is provided. Stopper 21a limits the length of insertion of the sewing needle and punch needle 5 into hole 21, in other words, determines the height of their attachment into hole 21 by establishing contact with the upper end of the base section of the sewing needle and punch needle 5.

As will be later described in detail, a cut known as a D-cut is formed on the base section of sewing needle and punch needle 5 such that a plane is partially defined on their cylindrical perimeters. As shown in FIG. 4B, hole 21 has planar rear wall 21b to allow a fitting engagement with the planar section of the base section of the sewing needle or punch needle 5. Though not shown in detail, needle clamp 20 is provided with a threaded hole not shown communicating with hole 21 into which the sewing needle and punch needle 5 are inserted and fastener screw 20a shown in FIG. 1 for securing the base section of the sewing needle and punch needle 5. The engagement of fastening screw 20a may be tightened or loosened by the user by turning. When tightened, the tip of fastening screw 20a is pressed in contact with the base section of the sewing needle and punch needle 5 and when loosened, the tip is separated from the base section to allow the attachment and detachment of the sewing needle and punch needle 5. Needle clamp 20, hole 21, and stopper 21a are examples of engagement subjects. The foregoing is an exemplary configuration of the engagement subject and thus, in an alternative embodiment, needle clamp 20 may be secured to the lower end of needle bar 6 and a hole serving as a functional equivalent of hole 21 and being provided with stopper 21a may be provided at needle clamp 20.

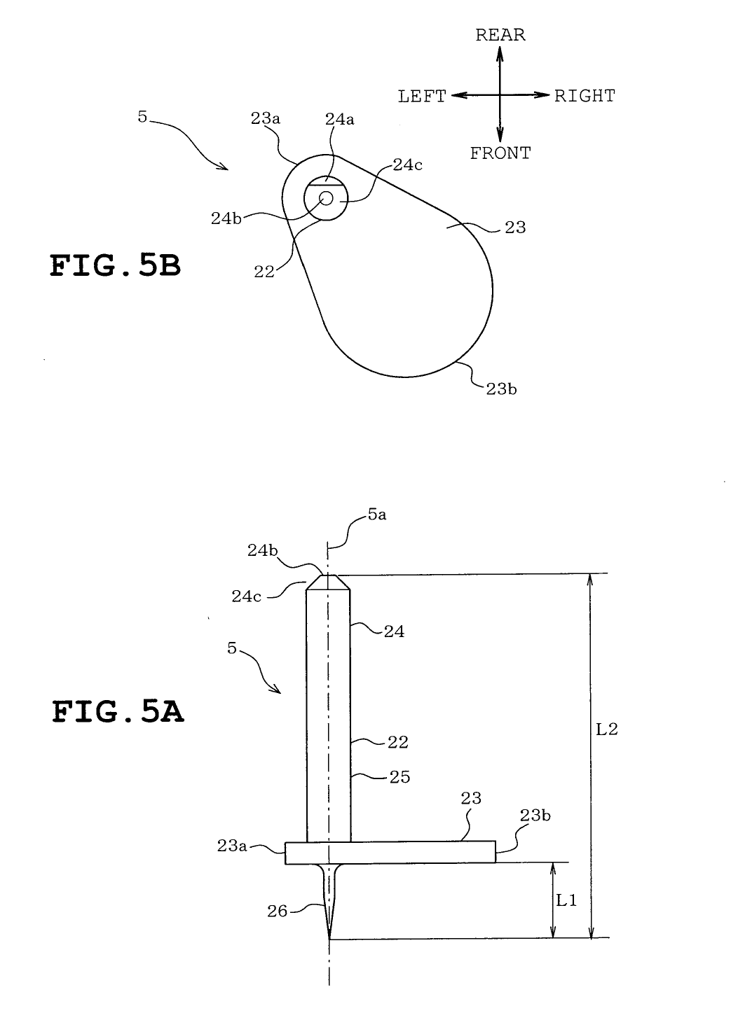

Punch needle of the first embodiment can be held firmly by the user and can be readily attached to/detached from needle bar 6. The structure of punch needle 5 is described in detail hereinafter with reference to FIGS. 5A to 7B. Punch needle 5 comprises needle body 22, and handle 23 which is held by the user's fingers. More specifically, needle body 22 is made of metal and is an integral structure including base section 24, mid section 25, and tip section 26. Base section 24, mid section 25, and tip section 26 are concentric on central axis 5a and extends sequentially and continuously along central axis 5a. Base section 24 and mid section 25 are generally cylindrical whereas tip section 26 terminates into a pointed tip.

Base section 24 serves as an engagement section being attached to/detached from needle clamp 20 and hole 21 of needle bar 6 from below. Base section 24 is provided with D-cut section 24a shown in FIG. 6C which is planar section partially defined on the rear side of the cylindrical perimeter of punch needle 5. The naming comes from the horizontal cross section of this portion which is shaped like a “D”. Base section 24 is provided with upper end 24b which is placed in contact with stopper 21a and taper 24c which is inclined so as to reduce the width of base section 24 toward upper end 24b. Punch needle 5 is inserted into hole 21 of needle bar 6 such that upper end 24b of base section 24 contacts stopper 21a. Once the vertical positioning of punch needle 5 has been determined by the contact between upper end 24b and stopper 21a, fastening screw 20a is tightened to lock punch needle 5 in place. When punch needle 5 is attached to needle bar 6, D-cut section 24a serves as a positioning section that determines the circumferential positioning of punch needle 5 relative to needle bar 6. That is, the planar section of D-cut section 24a contacts rear wall 21b of hole 21 formed in needle bar 6 or the hole formed in needle clamp 20 in the alternative embodiment. D-cut section 24a is formed in the rear side of the sewing needle or punch needle 5 in the first embodiment to establish the circumferential positioning, which may be rephrased as the rotational position, of handle 23 to a location which does not interfere with the later described peripheral components.

Mid section 25 interposes base section 24 and tip section 26 of body 24 and extends in continuation from base section 24. The diametric dimension of the cylindrical mid section 25 is identical to the measurement of base section 24 with the exception of D-cut section 24a. At the distal end of mid section 25 relative to base section 24, a pair of fitting subjects exemplified as slots 25a are provided to allow the fitting engagement of handle 23. Slots 25a open up toward tip section 26 and extend upward from the lower opening as well as diametrically inward of mid section 25. Further, slots 25a are laterally symmetrical in front view as shown in FIG. 6A and each receives the fitting engagement of handle 23 from the lower side. Because two slots 25a have been provided on two circumferentially distant portions of the perimeter of mid section 25 having a relatively wide diameter, handle 23 can establish a firm fitting engagement with mid section 25. In the first embodiment, the height of handle 23 fitted with slots 25a is configured at L1 which is measured from the tip of tip section 26 to the underside of handle 23 shown in FIG. 5A, which may be rephrased as length L1 of tip section 26 taken along central axis 5a. Height L1 of holder 23 is configured at a height that does not allow handle 23 to come in contact with any workpiece W or any component of sewing machine M1 such as upper frame 15 shown in FIG. 3 during a punching operation. More specifically, assuming that the position of the tip of tip section 26 when needle bar 6 is in the lowermost position is represented by P0, the length measured from the tip P0 to the upper surface of upper frame 15 is represented as L0. The height L1 of handle 23 is configured to be greater than length L0 (L0<L1) and thus, reliably prevents the handle from interfering with upper frame 15.

Tip section 26 is formed at the tip of mid section 25. Tip section 26 is configured so as to be relatively smaller in diameter as compared to base section 24 and mid section 25 and is pointed toward the lower end tip.

Length L2 of needle body 22 comprising base section 24, mid section 25, and tip section 26 is configured to be less than the axial length of the sewing needle. Punch needle 5 is configured to be shorter than the sewing needle since punch needle 5 is intended to leave markings such as holes on workpiece W but not intended to completely penetrate placement 18 at the lowermost position of needle bar 6. Further, unlike the sewing needle, needle body 22 is not provided with a needle eye. The comparison of the lengths of punch needle 5 and the sewing needle is given in FIG. 9 of the later described second embodiment.

As can be seen in FIGS.7A and 7B, handle 23 is configured as a plate member made, for instance, of synthetic resin. Handle 23 has proximal end 23a which is formed into a shape of a circular arc that rests along the outer perimeter of mid section 25 when handle 23 is attached to punch needle 5. Handle 23 is further provided with distal end 23b which is also formed into a circular arc and radially greater than proximal end 23a. Thus, handle 23 is shaped so as to increases its width from proximal end 23a to distal end 23b, in other words, in the forwardly rightward direction as indicated in the navigation arrows in FIG. 7B. Near proximal end 23a of handle 23, insert hole 28 is defined that receives insertion of the lower end of mid section 25 of needle body 22. In more detail, the lower end of mid section 25 is pressed into insert hole 28 is provided with a pair of fitting sections 28a configured as corners protruding radially inward which are fitted with fitting sections 25a formed on mid section 25 of punch needle 5. The fitting engagement between slots 25a of mid section 25 and fitting sections 28a locks handle unrotatably in the circumferential direction. Handle 23 is secured to mid section 25 with an adhesive.

As a result, handle 23 is structurally integrated with mid section 25 and extends in the direction orthogonal to needle body 22 and central axis 5a as shown in FIG. 5A. Further, as shown in FIG. 5B, because handle 23 protrudes radially outward in a spreading manner, the user is given a firm grip of handle 23. As mentioned earlier, distal end 23b of handle 23 protrudes forwardly rightward relative to needle bar 6 when punch needle 5 is attached to needle bar 6.

Next, a description will be given on the operation of the above described structure. Sewing machine M1 of the first embodiment is capable of executing a punching operation for creating the desired punch pattern on workpiece W in addition to the execution of a normal embroidery sewing operation.

Prior to the punching operation, the user is to secure workpiece W such as a sheet of paper to holder frame 10 and attach holder frame 10 to carriage 11a of transfer device 11. After removing the sewing needle by loosening fastening screw 20a of needle clamp 20, the user is to firmly hold punch needle 5 by handle 23 and insert base section 24 into hole 21 of at the lower end of needle bar 6 from below. By inserting base section 24 until upper end 26b is placed in contact with stopper 21a of hole 21 as shown in FIG. 4A, the vertical position of punch needle 5 relative to needle bar 6, that is, the height of attachment is determined. Then, fastening screw 20a is fastened to secure punch needle to needle bar 6. At this instance, D-cut section 24a establishes the circumferential positioning of punch needle 5 relative to needle bar 6.

In case base section 24 is shaped as a round bar without D-cut 24a, punch needle may rotate unwantedly in the circumferential direction relative to needle bar 6 by being urged by oscillatory movements, etc. caused by the striking of punch needle 5. Rotation of punch needle 5 may displace handle 23 projecting radially outward and possibly collide with components in the proximity punch needle 5. D-cut section 24a unmovably locks the circumferential position of punch needle 5 relative to needle bar 6 to prevent such problems.

Handle 23 allows the user to hold punch needle 5 firmly during the attachment of punch needle 5 which is shorter than the sewing needle. Moreover, in view of D-cut 24a provided on the rear side of needle bar 6 in the first embodiment, handle 23 is configured to protrude forwardly rightward toward the user from needle bar 6 which facilitates the user's attachment of punch needle 5.

After attaching punch needle 5, the user is to select punch data of the desired punch pattern through sewing machine M1. The controller, responsible for the overall control of sewing machine Ml, executes a punch control program to control the sewing machine motor and the X-direction transfer mechanism and the Y-direction transfer mechanism of transfer device 11 to execute the punching operation to workpiece W held by holder frame 10 using punch needle 5. By striking punch needle 5 against the top surface of workpiece W held by holder frame 10, multiple markings typically comprising small holes are formed to obtain workpiece W decorated with a desired pattern. Because handle 23 is located at height L1 of punch needle 5 it will not interfere with other components of sewing machine M1 such as upper frame 15 during the punching operation. Further, because punch needle 5 is locked unrotatably relative to needle bar 6 by D-cut section 24a, handle 23a will not be circumferentially displaced during the punching operation.

After completing the creation of punch patterns, the user is allowed to readily remove punch needle 5 from needle bar 6 through a firm hold of punch needle 5 established through handle 23 as was the case in the attachment of punch needle 5.

As described above, punch needle 5 of the first embodiment is provided with base section 24 detachably attached to needle bar 6, mid section 25 in continuation with base section 24, and tip section 26 formed at the tip of mid section 25. Mid section 25 is provided with handle 23 which is held by the user's fingers in the attachment/detachment of punch needle 5 to/from needle bar 6. Handle 23 allows the user to establish a firm hold of punch needle 5 though it is much shorter than the sewing needle and was conventionally difficult to hold. Thus, punch needle 5 can be held firmly by the user's fingers by gripping handle 23 to facilitate the attachment/detachment of punch needle 5 to and from needle bar 6 of sewing machine M1.

Handle 23 is provided on mid section 25 at a predetermined height taken in the direction of central axis 5a. Thus, handle 23 is prevented from colliding with workpiece W or other components of sewing machine M1 such as holder frame 10 during the punching operation.

Handle 23 is configured by a plate member and thus is easy to hold and easy to make. Further, the plate member is configured to extend in the direction orthogonal to'central axis 5a and thus, can be sized as desired unlimited by the length of punch needle 5 taken along central axis 5a.

Handle 23 made of a plate member is configured such that its proximal end 23a is secured to the mid section 25. Thus, the attachment of handle 23 can be established in a simple and compact structure. Because the plate member increases its width toward distal end 23b from proximal end 23a, sufficient space can be created for holding the plate member.

D-cut section 24a locks base section 24 relative to needle bar 6 at a circumferential position where handle 23 does not interfere with other components of sewing machine M1. Thus, handle 23 does not get in the way of punching operation after punch needle 5 is attached to needle bar 6 of sewing machine M1 and yet facilitate the attachment/detachment of punch needle 5, thereby improving user friendliness.

FIGS. 8 and 9 illustrate a second embodiment of the present disclosure and the elements that are identical to the first embodiment are represented by identical reference symbols and will not re-described. The following description will focus on the differences between the first and the second embodiment. The second embodiment differs from the first embodiment in that punch needle 5 is applied to a multi-needle embroidery sewing machine hereinafter referred to a multi-needle sewing machine M2.

First a description will be given on the general structure of multi-needle sewing machine M2. The following description defines the left and right direction relative to multi-needle sewing machine M2 as the X direction and the front and rear direction as the Y direction as indicated in FIGS.8 and 9.

As shown in FIG. 8, multi-needle sewing machine M2 is primarily configured by components such as support base 30 placed on a placement base not shown, pillar 31 standing on the rear end of support base 30, arm 32 extending forward from the upper portion of pillar 31, and needle-bar case 33 attached to the front end of arm 32. Support base 30 is provided with a pair of fowardly extending left and right feet 30a, thereby exhibiting a U-shape in top view that has a forward opening. From the rear portion of support base 30, cylinder bed 34 extends forward so as to be centered between the left and right feet 30a. On the upper edge of cylinder bed 34 distal from pillar 31, needle plate 34a is provided that has needle hole defined through it. Cylinder bed 34 contains a hook not shown that seizes the sewing thread.

Above feet 30a, Y-direction carriage 36 is provided that is oriented in the left and right direction. In front of Y-direction carriage 36, a frame holder not shown is provided by way of X-direction carriage 37. Y-direction carriage 36 contains an X-direction drive mechanism not shown is provided that transfers the frame holder in the X-direction which represent the left and right direction. Feet 30a contains a Y-direction drive mechanism not shown that drives Y-direction carriage 36 in the Y direction representing the front and rear direction. Though not shown, the frame holder allows detachable attachment of an embroidery frame for holding a workpiece or holder frame for holding workpiece W. Though not shown, the holder frame is configured by an upper frame and a lower frame that clamps workpiece W just like holder frame 10 shown in FIG. 2. A connecting section provided on the lower frame is configured in a shape that allows attachment to frame holder. The embroidery frame or the holder frame is thus, is driven in the Y direction with Y-direction carriage 36 or in the X direction with the frame holder by being driven by the Y-direction drive mechanism and the X-direction drive mechanism. The embroidery frame and the holder frame come in different sizes in shapes as an accessory to multi-needle sewing machine M2 and are configured so as to be detachably attached to the frame holder.

As shown in FIG. 9, needle-bar case 33 supports six vertically extending needle bars 38 that are arranged side by side in the left and right direction. Needle bars 38 are allowed to move up and down and the lower end of each needle bar 38 serves as an attachment subject that allows attachment of sewing needle 39 or punch needle 5. Needle-bar case 33 is further provided with six vertically movable thread take-ups that are associated with the six needle bars 38.

Needle-bar case 33 has a forwardly declining thread tension regulator base 40 provided with six thread tension regulators, though only their mounting slots are shown, for thread tension adjustment. On the upper end of thread tension regulator base 40, six thread guides 40a are provided. Behind thread tension regulator base 40, a thread spool stand capable of holding six thread spools for example is provided so as to be located at the upper rear portion of arm 32. Needle thread drawn from the thread spools set to the thread spool stand is passed through components such as thread guide 40a, the thread tension regulator, and the thread take-up in the listed sequence and is finally passed through the eye not shown of sewing needle 39 to be ready for an embroidery sewing operation.

Though not shown, arm 32 contains a main shaft driven by a sewing machine motor known in the field, a needle-bar vertically moving mechanism that moves components such as needle bar 38 up and down by the rotation of the main shaft, and a needle-bar selection mechanism that moves needle-bar case 33 in the X-direction to select either of needle bars 38. Needle-bar case 38 is driven by needle-bar selection motor not shown to move either of the six pair of needle bars 38 and thread take-ups to a position immediately above needle hole 34b. The selected needle bar 38 and the thread take-up is moved up and down by the needle-bar vertically moving mechanism. The rotation of the main shaft also drives the hook for seizing the sewing thread. On the right side of arm 32, a control panel not shown is provided. The control panel is provided with a variety switches for providing various instructions and for making selections and inputs and a liquid crystal display for displaying for displaying various information required in a sewing operation.

As can be seen in FIG. 9, needle-bar case 33 is longitudinally thin, and comes in a shape of a rectangular box. Needle-bar case 33 contains a plurality of needle bars 38, six, in the present exemplary embodiment, aligned in the left and right direction so as to be movable up and down. Each needle bar 38 is supported so as to be moveable up and down and is subjected to consistent upward bias toward the uppermost position not shown by a coil spring not shown. The six needle bars 38 are identified by needle bar numbers 1 to 6, in this case, in ascending order from right to left.

The lower ends of these needle bars 38 extend downward out of needle-bar case 33 and sewing needle 9 used for embroidery sewing is detachably/interchangeably attached to them. The six needle bars 8 are identified by needle bar numbers 1 to 6, in this case, in ascending order from right to left. In the present exemplary embodiment, the leftmost specific needle bar 8 among the six needle bars 8, that is, the no.6 needle bar 8, has punch needle 5 detachably attached to it instead of sewing needle 9. Punch needle 5 will be later described in detail.

Each of needle bars 38 has its lower end protruding downward from needle-bar case 33. At the lower end of each needle bar 38, needle clamp 41 is provided for mounting the sewing needle or punch needle 5 on needle bar 6. Needle clamp 41 has hole 43 into which base section 39a at the upper portion of sewing needle 39 or base section 24 of punch needle 5, hereinafter simply referred to as base section 39a and base section 24, is inserted from below. Hole 43 is provided with rear wall 21b as was the case in hole 21 of needle bar 6 of sewing machine M1 which is configured in the shape of a D-cut for establishing a fitting engagement with base sections 24 and 39a. At the upper portion of hole 43, stopper 21a is provided. Stopper 21a limits the length of insertion of base sections 24 and 39a into hole 43, in other words, determines the height of their attachment into hole 43 by establishing contact with the upper end of base sections 24 and 39a of sewing needle 39 and punch needle 5. On the front face of needle clamp 41, fastening screw 41a is provided for securing base sections 24 and 39a. Fastening screw 41a has a hexagonal hole and the user is to tighten or loosen fastening screw 41a from the front side by a hexagonal wrench for attachment/detachment of sewing needle 39 and punch needle 5. Needle clamp 41 including elements such as hole 43, stopper 21a, and fastening screw 41a-are examples of the aforementioned attachment subject provided at the lower end of needle bar 38.

At the lower portion of each needle bar 38, presser foot 44 is provided that is moved up and down in synchronism with needle bar 38. As shown in FIG. 9, presser foot 44 is an integral structure formed by bending and comprises mounting piece 44a mounted on the lower of needle bar 38, vertical plate 44b extending downward from the left and of mounting piece 44a, and needle drop hole section 49c that extends from the lower end of vertical plate 44b toward the tip of sewing needle 39. Vertical plate 44b is provided on the left side of needle clamp 41 and sewing needle 39 extends vertically along the entire length of needle clamp 41 and sewing needle 39 so as to embrace them.

Next, a description will be given on the operation of the above described structure. Multi-needle sewing machine M2 of the second embodiment is capable of executing a punching operation for creating the desired punch pattern on workpiece W in addition to the execution of a normal embroidery sewing operation.

Prior to the punching operation, the user is to secure workpiece W such as a sheet of paper to the holder frame and attach the holder frame to the frame holder. Then, as shown in FIG. 9, punch needle 5 is attached to the leftmost needle bar 38 identified by needle bar number 6. That is, in case sewing needle 39 is attached to each of needle bars 38 numbered from no.1 to 6, presser foot 44 is removed from needle bar 38 no. 6, for instance, sewing needle 39 is replaced by punch needle 5. Then, the user is to firmly hold punch needle 5 by handle 23 and insert base section 24 into hole 43 at the lower end of needle bar 38 from below. As in the first embodiment, base section 24 is inserted until its upper end 24b is placed in contact with stopper 21a of hole 43. The vertical position of punch needle 5 relative to needle bar 38, that is, the height of attachment is thus, determined, whereafter fastening screw 20a is fastened to secure punch needle 5 to needle bar 38.

At this instance, D-cut section 24a establishes the circumferential positioning of punch needle 5 such that handle 23 does not contact other components such as vertical plate 44b of presser foot 44. When punch needle-5 is attached to needle bar 38, vertical plate 44b resides immediately beside it. In the second embodiment, vertical plate 44b resides on the right side of punch needle 5. Thus, handle 23, when attached, is projected forwardly rightward relative to needle bar 6 so as not to contact vertical plate 44b.

After attaching punch needle 5, the user is to select punch data of the desired punch pattern through multi-needle sewing machine M2. The controller, responsible for the overall control of multi-needle sewing machine M2, executes a punch control program to control the sewing machine motor and the X-direction transfer mechanism and the Y-direction transfer mechanism of transfer device 11 to execute the punching operation to workpiece W held by the holder frame using punch needle 5. As was the case in the first embodiment, multiple markings typically comprising small holes are formed to obtain workpiece W decorated with a desired punch pattern.

As describe above, the second embodiment allows application of punch needle 5 to multi-needle sewing machine M2. That is, as described above, handle 23 located at the lower portion of needle bar 38 reliably prevented from contact with other neighboring components such as presser foot 44. Further, the second embodiment provides the advantages of the first embodiment such as facilitating attachment/detachment of punch needle 5 by providing handle 23 that allows firm hold of punch needle 5 by the user.

The present disclosure is not limited to the above described embodiments but may be modified or expanded as follows.

Punch needle 5 is not limited to the application to sewing machines M1 and M2 but maybe applied to various types of sewing machines.

Handle 23 was secured to needle body 22 of punch needle 5 with an adhesive. Instead, handle 23 may be structurally integrated with needle body 22 by insert molding handle 23 into needle body 22. Further, needle body 22 and handle 23 may be made of various materials and the needle body and the handle may be configured as an integral structure made of the same material.

Punch needle 5 may come in any shape that is suitable for creating punch patterns. For instance, the tip ‘section may have a ball point. Sewing machine M1 and M2 may be provided with variety of punch needles 5 differing in sizes and shapes such as sharp pointed and ball pointed tips. A punch needle with a ball pointed tip will form multiple recesses on work piece W.

The term “other components” used herein is intended to include components of sewing machine M1 and M2 that may come in contact with handle 23 when punch needle 5 is in attachment with the attachment subject of the needle bar. Handle 23 can avoid contact with “other components” by being configured in the dimensions described above.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A punch needle that is detachably attached to a needle bar of a sewing machine and that is configured to punch a workpiece by moving the needle bar up and down, the punch needle comprising:
a base section detachably attached to the needle bar;
a mid section in continuation with the base section;
a tip section formed on the end of the mid section; and
a handle provided on the mid section, the handle being configured to be held by a user's fingers during attachment/detachment of the base section to/from the needle bar.

2. The punch needle of claim 1, wherein the handle is provided at a predetermined height taken along a central axis of the mid section to prevent contact between the workpiece and other components of the sewing machine when punching the workpiece.

3. The punch needle of claim 1, wherein the handle comprises a plate member extending in a direction orthogonal to the central axis.

4. The punch needle of claim 2, wherein the handle comprises a plate member extending in a direction orthogonal to the central axis.

5. The punch needle of claim 3, wherein the plate member comprises a proximal end having a first width fixed to the mid section and a distal end having a second width greater than the first width.

6. The punch needle of claim 4, wherein the plate member comprises a proximal end having a first width fixed to the mid section and a distal end having a second width greater than the first width.

7. The punch needle of claim 3, wherein the base section includes a positioning section that is configured to determine a circumferential positioning of the punch needle relative to the needle bar, the positioning section being configured to determine the circumferential position such that the plate member projects in a direction that does not contact other components of the sewing machine when the base section is attached to the needle bar.

8. The punch needle of claim 4, wherein the base section includes a positioning section that is configured to determine a circumferential positioning of the punch needle relative to the needle bar, the positioning section being configured to determine the circumferential position such that the plate member projects in a direction that does not contact other components of the sewing machine when the base section is attached to the needle bar.

9. The punch needle of claim 5, wherein the base section includes a positioning section that is configured to determine a circumferential positioning of the punch needle relative to the needle bar, the positioning section being configured to determine the circumferential position such that the plate member projects in a direction that does not contact other components of the sewing machine when the base section is attached to the needle bar.

10. The punch needle of claim 6, wherein the base section includes a positioning section that is configured to determine a circumferential positioning of the punch needle relative to the needle bar, the positioning section being configured to determine the circumferential position such that the plate member projects in a direction that does not contact other components of the sewing machine when the base section is attached to the needle bar.

11. A sewing machine comprising:
a needle bar configured to move up and down;
a punch needle detachably attached to the needle bar and configured to punch a workpiece by the up and down movement of the needle bar;
wherein the punch needle includes abase section detachably attached to the needle bar, a mid section in continuation with the base section, a tip section formed on the end of the mid section, and a handle provided on the mid section, the handle being configured to be held by a user's fingers during attachment/detachment of the base section to/from the needle bar.
